(19) United States
(12) Patent Application Publication
(10) Pub. No.: US 2025/0337248 A1
(43) Pub. Date: Oct. 30, 2025

(54) DISTRIBUTED POWER SUPPLY INTEGRATION MANAGEMENT DEVICE AND POWER SYSTEM

(71) Applicant: Mitsubishi Electric Corporation, Tokyo (JP)

(72) Inventors: Koki MATSUMOTO, Chiyoda-ku, Tokyo (JP); Sadayuki INOUE, Chiyoda-ku, Tokyo (JP); Daisuke TERAZONO, Chiyoda-ku, Tokyo (JP); Rutvikanandan MANOHAR, Chiyoda-ku, Tokyo (JP); Yasuhiro KOJIMA, Chiyoda-ku, Tokyo (JP); Keishi MATSUDA, Chiyoda-ku, Tokyo (JP)

(73) Assignee: Mitsubishi Electric Corporation, Tokyo (JP)

(21) Appl. No.: 18/854,564

(22) PCT Filed: Apr. 19, 2022
(86) PCT No.: PCT/JP2022/018187

§ 371 Date: Oct. 7, 2024

(51) Int. Cl. H02J 3/38; H02J 13/00

(52) U.S. Cl. CPC H02J 3/381; H02J 13/00002

(57) ABSTRACT

A distributed power supply integration management device manages a usage state of a power grid having distributed power supplies connected thereto, output voltages of the distributed power supplies being controlled by a virtual synchronous generator control function that implements operation characteristics of a synchronous generator in a static power supply in a simulative manner. A reception unit receives information about an operation state of each of the distributed power supplies. An operation determination unit determines an operation pattern of the distributed power supplies based on the information obtained by the reception unit. In the determined operation pattern, a control parameter determination unit determines a control parameter value for the virtual synchronous generator control, such that mutual interference of the virtual synchronous generator control in the distributed power supplies can be avoided and the power grid can operate in a stable manner.

### TECHNICAL FIELD

The present disclosure relates to a distributed power supply integration management device and a power system.

### BACKGROUND ART

Because of the demand for decarbonization, the introduction of distributed power supplies using the renewable energy into a power grid is accelerating. These distributed power supplies are connected to the grid by using a static power conversion device without rotational movement. Therefore, these distributed power supplies are characterized by not having the grid voltage maintaining effect (so-called inertia force) resulting from the inertia of rotational movement, as compared with a rotating machine power supply such as a synchronous generator that has conventionally served as a main power supply of a power grid. Thus, as a ratio of a power supply using a static power conversion device (hereinafter, also referred to as “static power supply”) increases, a decrease in stability of a power grid is concerned.

In order to deal with this, a virtual synchronous generator control technique to impart inertia force to a static power supply by implementing, in the static power supply, control that simulates dynamic characteristics equivalent to those of a rotating machine power supply is proposed. For example, Japanese Patent No. 6084863 (PTL 1) describes a specific control method for virtual synchronous generator control. Particularly, PTL 1 describes a power conversion device that can continue to operate without using a phase locked loop (PLL) circuit for grid frequency detection, when a grid voltage or a grid frequency varies.

### CITATION LIST

### Patent Literature

PTL 1: Japanese Patent No. 6084863

### SUMMARY OF INVENTION

### Technical Problem

By introducing the virtual synchronous generator control technique described in PTL 1, even a static power supply can contribute to the stability of a power grid. As a result, it is expected that concerns about the stability are eliminated and an introduction ratio of a static power supply is increased, which contribute to decarbonization.

However, when a plurality of static power supplies each implementing the virtual synchronous generator control are connected and operate simultaneously in a power grid or in a microgrid operating in a standalone manner, control systems of different distributed power supplies may interfere with each other and the divergent operation may be induced, depending on control parameter values. As a result, it is concerned that an unstable phenomenon occurs in the above-described power grid or microgrid.

Therefore, in a grid where a plurality of distributed power supplies coexist, it is concerned that when the individual distributed power supplies determine or change control parameters at their own convenience, consistency of the entire grid cannot be maintained and the above-described unstable phenomenon occurs, which make stable power supply impossible.

The present disclosure has been made to solve the above-described problem, and an object of the present disclosure is to provide a distributed power supply integration management device for avoiding the occurrence of an unstable phenomenon caused by mutual interference of control among a plurality of distributed power supplies connected to a power grid, and performing stable power supply.

### Solution to Problem

In an aspect of the present disclosure, a distributed power supply integration management device is provided. The distributed power supply integration management device manages a usage state of a power grid having a plurality of distributed power supplies connected thereto, output voltages of the plurality of distributed power supplies being controlled by virtual synchronous generator control that implements operation characteristics of a synchronous generator in a static power supply in a simulative manner. The distributed power supply integration management device includes: a reception unit; an operation determination unit; a control parameter determination unit; and a transmission unit. The reception unit receives information about an operation state of each of the plurality of distributed power supplies. The operation determination unit determines an operation pattern of the plurality of distributed power supplies based on the information obtained by the reception unit. In the operation pattern determined by the operation determination unit, the control parameter determination unit determines a control parameter value for the virtual synchronous generator control in each of the plurality of distributed power supplies, such that mutual interference of the virtual synchronous generator control in the plurality of distributed power supplies can be avoided and the power grid can operate in a stable manner. The transmission unit transmits, to each of the plurality of distributed power supplies, an operation command corresponding to the operation pattern determined by the operation determination unit and the control parameter value determined by the control parameter value determination unit.

In another aspect of the present disclosure, a power system is disclosed. The power system includes: a power grid; the above-described distributed power supply integration management device; and a communication path formed between the distributed power supply integration management device and a plurality of distributed power supplies. The power grid has the plurality of distributed power supplies connected thereto, output voltages of the plurality of distributed power supplies being controlled by virtual synchronous generator control that implements operation characteristics of a synchronous generator in a static power supply in a simulative manner.

### Advantageous Effects of Invention

According to the present disclosure, it is possible to avoid the occurrence of an unstable phenomenon caused by mutual interference of control among a plurality of distributed power supplies connected to a power grid, and perform stable power supply to the power grid.

### BRIEF DESCRIPTION OF DRAWINGS

FIG. 1 is a block diagram illustrating a schematic configuration of a power system managed by a distributed power supply integration management device according to a first embodiment.

FIG. 2 is a block diagram illustrating a configuration example of a distributed power supply.

FIG. 3 is a block diagram illustrating a control configuration example of virtual synchronous generator control applied to each distributed power supply.

FIG. 4 is a block diagram illustrating an internal configuration of the distributed power supply integration management device according to the first embodiment.

FIG. 5 is a block diagram showing an example of a power system in which a plurality of distributed power supplies according to a comparative example each implementing the virtual synchronous generator control are connected to a power grid.

FIG. 6 is a first simulation waveform diagram of outputs of the distributed power supplies in the power supply system shown in FIG. 5.

FIG. 7 is a second simulation waveform diagram of outputs of the distributed power supplies in the power supply system shown in FIG. 5.

FIG. 8 is a conceptual diagram illustrating linear approximation performed on output power characteristics of the distributed power supply in order to introduce a state equation.

FIG. 9 is a conceptual diagram illustrating the size of a coefficient matrix A of the state equation.

FIG. 10 is a flowchart illustrating an example of a procedure of a process of determining control parameter values in the distributed power supply integration management device according to the first embodiment.

FIG. 11 is an example of a block diagram showing control transfer characteristics of a power grid including a transfer function used in a distributed power supply integration management device according to a second embodiment.

FIG. 12 is a conceptual diagram illustrating a gain margin and a phase margin of an open-loop transfer function.

FIG. 13 is a block diagram illustrating an internal configuration of a distributed power supply integration management device according to a third embodiment.

FIG. 14 is a block diagram illustrating an internal configuration of a distributed power supply integration management device according to a fourth embodiment.

### DESCRIPTION OF EMBODIMENTS

Embodiments of the present disclosure will be described in detail hereinafter with reference to the drawings, in which the same or corresponding portions are denoted by the same reference characters and description thereof will not be repeated in principle.

### First Embodiment

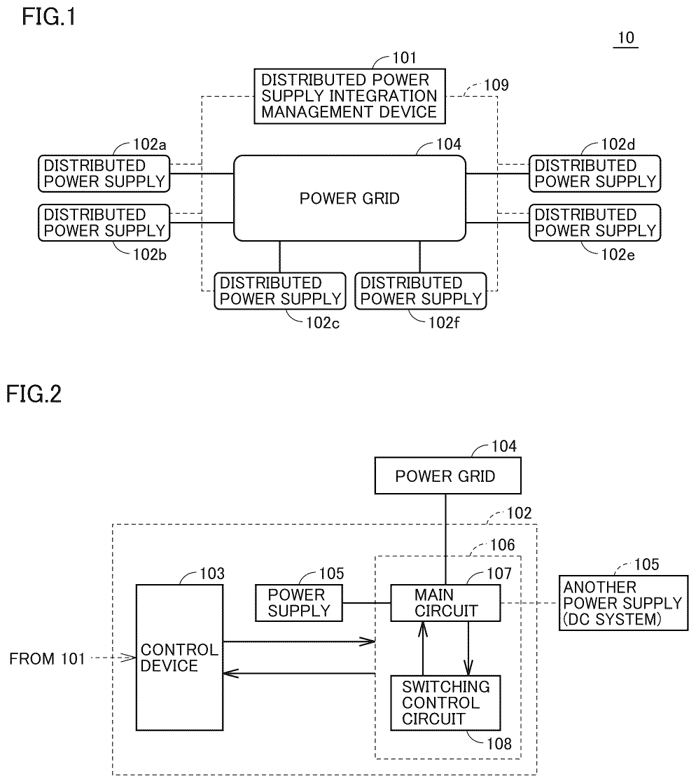

FIG. 1 is a block diagram illustrating a schematic configuration of a power system 10 managed by a distributed power supply integration management device 101 according to a first embodiment and including a plurality of distributed power supplies.

As shown in FIG. 1, power system 10 includes distributed power supply integration management device 101, a plurality of distributed power supplies 102a to 102f, a communication path 109 formed between distributed power supply integration management device 101 and distributed power supplies 102a to 102f, and a power grid 104 to which the plurality of distributed power supplies 102a to 102f are connected.

Power grid 104 is a network including a not-shown power supply and a not-shown customer, and a power line (not shown) that electrically connects the power supply and the customer. The scale of this network may be an entire jurisdiction area managed by a general power transmission and distribution company, or may be a standalone microgrid used independently at a particular municipal scale, or may be a power distribution network in a particular building. Power grid 104 may be a system using any one of a three-phase alternating current (AC) and a single-phase alternating current.

Each of distributed power supplies 102a to 102f refers to a distributed power supply whose output voltage is controlled by below-described virtual synchronous generator control and which is managed by distributed power supply integration management device 101, of the distributed power supplies connected to power grid 104. In the following description, when distributed power supplies 102a to 102f are collectively denoted, they will also be simply referred to as a distributed power supply 102. Distributed power supply 102 can be configured by a photovoltaic power generation system, a wind power generation system, a storage battery system or the like.

FIG. 2 shows a block diagram illustrating a configuration example of distributed power supply 102.

Referring to FIG. 2, distributed power supply 102 includes a control device 103, a power supply 105 and a power conversion device 106.

Power supply 105 can be configured by a power generation element such as a photovoltaic cell or a wind generator, or a power storage element such as a battery or a capacitor. Power conversion device 106 is a “static power supply” that converts electric power from power supply 105 into AC power for interconnecting with power grid 104. That is, power conversion device 106 has a main circuit 107 that performs power conversion by controlling ON/OFF of a semiconductor switching element (not shown), and a switching control circuit 108 that generates an ON/OFF control signal for the semiconductor switching element in main circuit 107.

Control device 103 generates an operation command for power conversion device 106 in accordance with information from distributed power supply integration management device 101 shown in FIG. 1. As described below, in the present embodiment, control device 103 controls the output voltage of distributed power supply 102 by the virtual synchronous generator control using control parameter values from distributed power supply integration management device 101. That is, in control device 103, the operation command for controlling power conversion in main circuit 107 is generated in accordance with this virtual synchronous generator control. Control device 103 can be configured by, for example, a not-shown microcomputer including a processor such as a central processing unit (CPU), a memory and the like.

Switching control circuit 108 controls ON/OFF of the semiconductor switching element in main circuit 107 such that power conversion in main circuit 107 is performed in accordance with the operation command from control device 103.

Distributed power supply 102 is not limited to the configuration having a power generation device or a power storage device built thereinto, and may be configured to convert electric power from another power supply such as a direct-current (DC) system into AC power as illustrated by a dotted line in FIG. 2.

Referring again to FIG. 1, in power system 10, the number N (N: natural number) of distributed power supplies 102 is any number equal to or greater than two. Although FIG. 1 shows the example of N=6, it is needless to say that N>6 or 2≤N<6 may also be possible.

Communication path 109 is formed between distributed power supply integration management device 101 and each of distributed power supplies 102. Communication path 109 can be formed by any of wired connection and wireless connection. Distributed power supply integration management device 101 receives and transmits information to and from each of distributed power supplies 102a to 102f through communication path 109, and manages an operation state of each of distributed power supplies 102a to 102f.

The virtual synchronous generator control applied to each of the distributed power supplies will now be described.

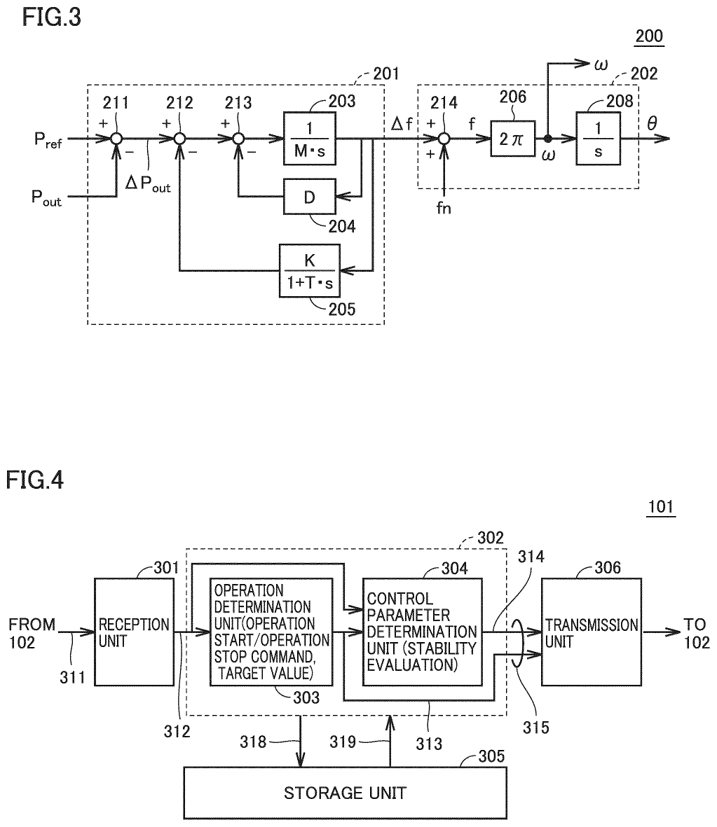

FIG. 3 is a block diagram illustrating a control configuration example of the virtual synchronous generator control applied to each of distributed power supplies 102. As described above, the virtual synchronous generator control is control for causing the static power supply (main circuit 107) to have operation characteristics equivalent to those of a rotating machine power supply in a simulative manner.

For example, the function of a distributed power supply control unit 200 shown in FIG. 3 can be implemented by software processing in which the microcomputer constituting control device 103 executes a prestored program. Alternatively, at least a part of the function of each block in FIG. 3 can also be implemented by hardware circuitry.

Referring to FIG. 3, distributed power supply control unit 200 includes a virtual synchronous generator control unit 201 and an operation command value generation unit 202. For example, operation command value generation unit 202 calculates a frequency f and a phase θ of an AC voltage output from distributed power supply 102, in accordance with a result of computation by virtual synchronous generator control unit 201. Switching control circuit 108 shown in FIG. 2 controls ON/OFF of the semiconductor switching element constituting main circuit 107, such that main circuit 107 outputs the AC voltage corresponding to calculated frequency f and phase θ.

First, operation characteristics of a normal rotating machine power supply simulated by the virtual synchronous generator control will be described. Generally, the rotating machine power supply has such a characteristic that a rotational speed of a rotor of the rotating machine power supply varies based on an oscillation equation shown in Equation (1) in accordance with mechanical input energy Pm input to the rotor from outside and electrical output energy Pe output to a grid.

$$[ Math . 1 ]$$

$${P}_{m} - {P}_{e} = M \frac{d}{dt} ω - D ( {ω}_{0} - ω ) \qquad ( 1 )$$

In Equation (1), ω represents a rotational speed of the rotor, ω₀ represents a rated rotational speed of the rotor, M represents an inertia constant of the rotor, and D represents a braking coefficient of the rotor. It is understood from Equation (1) that rotational speed ω of the rotor is maintained constant when mechanical input energy Pm and electrical output energy Pe are equal to each other (Pm=Pe). On the other hand, when Pm>Pe, the rotor is accelerated. When Pe>Pm, the rotor is decelerated. Rotational speed ω of the rotor is a constant multiple of frequency f of the AC voltage output by the rotating machine power supply (e.g., ω=2π·f).

The advantages of the rotating machine power supply derived from this characteristic will now be described. Although not limited to the rotating machine power supply, electrical output energy Pe can be shown by Equation (2), using a phase difference δ between a phase of an output voltage of a power supply connected to a power grid and a voltage phase on the power grid side.

$$[ Math . 2 ]$$

$${P}_{e} = {P}_{0} sin δ \qquad ( 2 )$$

In Equation (2), P₀ is a positive constant determined depending on an internal impedance and a voltage amplitude of a generator. Generally, phase difference δ is used within the range of 0<δ<90 [deg], and there is a positive correlation between Pe and phase difference δ within this range.

By having both of the characteristics in Equations (1) and (2), the advantages as described below are obtained.

For example, when phase difference δ increases suddenly due to an influence of disturbance or the like from a state in which the rotating machine power supply is in a steady operation state at Pm=Pe and at constant rotational speed ω, Pe increases in accordance with Equation (2). As a result, Pm becomes smaller than Pe (Pm<Pe), and thus, the rotor is decelerated in accordance with Equation (1). As a result, phase difference δ decreases gradually, and thus, the rotating machine power supply can return to the original steady operation state. Conversely, when phase difference δ decreases suddenly from the above-described steady operation state, Pe decreases in accordance with Equation (2). As a result, Pm becomes larger than Pe (Pm>Pe), and thus, the rotor is accelerated in accordance with Equation (1). As a result, phase difference δ increasingly decreases, and thus, the rotating machine power supply can return to the original steady operation state.

As described above, the rotating machine power supply has the advantage of being able to self-recover to the stable operation state by having the characteristic shown in Equation (1). In addition, based on the same principle, even when a plurality of different rotating machine power supplies operate in parallel, the rotating machine power supplies have the advantage of being able to eliminate a cross current occurring between the rotating machine power supplies and synchronize the rotational speed and the voltage phase.

In contrast, since the static power supply does not have the characteristic shown in Equation (1) above, the above-described advantage of compensating for variations in phase difference δ and self-recovering to the steady operation state cannot be obtained. Therefore, the virtual synchronous generator control is introduced in order to cause the static power supply to have the compensation characteristic corresponding to Equation (1) in a simulative manner.

As shown in FIG. 3, virtual synchronous generator control unit 201 has subtractors 211 to 213, an integrator 203, a feedback path 204, and a governor control unit 205.

Subtractor 211 subtracts an output active power measurement value Pₒᵤₜ from a command value of active power output from distributed power supply 102 (power conversion device 106) (hereinafter, an output active power command value P_{ref}), to calculate an active power deviation ΔPₒᵤₜ. Active power deviation ΔPₒᵤₜ passes through integrator 203 that uses an inverse (1/M) of inertia constant M in Equation (1) as an integration constant, and passes through feedback path 204 that multiplies an output value of integrator 203 by braking coefficient D in Equation (1), and is negatively fed back to subtractor 213.

Furthermore, the output value of integrator 203b is negatively fed back to subtractor 212 by governor control unit 205 having a first-order lag element (K/(1+T·s)) of gain K and time constant T.

The computation process by integrator 203 and feedback path 204 corresponds to the computation in the oscillation equation of the rotating machine shown in Equation (1). Furthermore, governor control unit 205 is a feedback path for adding characteristics corresponding to those of a governor provided in the rotating machine power supply. Virtual synchronous generator control unit 201 performs these control computations on active power deviation ΔPₒᵤₜ to calculate a frequency change amount Δf of the output voltage from distributed power supply 102 (power conversion device 106).

Operation command value generation unit 202 has an adder 214, a multiplier 206 and an integrator 208. Adder 214 adds a reference frequency fn of the above-described output voltage and frequency change amount Δf calculated by virtual synchronous generator control unit 201, to calculate a frequency command value f of the output voltage. Multiplier 206 multiplies frequency command value f output from adder 214 by 2π to calculate an angular frequency ω corresponding to the rotational speed. Integrator 208 integrates angular frequency ω output from multiplier 206, to calculate a phase command value θ of the output voltage.

In the configuration shown in FIG. 2, distributed power supply 102 is controlled such that the frequency and the phase of the output voltage (AC voltage) of power conversion device 106 becomes equal to above-described frequency command value f and phase command value θ. Distributed power supply 102 to which the virtual synchronous generator control is applied can thus obtain the operation characteristics equivalent to those of the rotating machine power supply, and obtain the ability to self-recover to the stable operation state and the ability to eliminate a cross current between the different power supplies and synchronize the frequency and the phase.

In the configuration illustrated in FIG. 3, inertia constant M included in integrator 203, braking coefficient D included in feedback path 204, and gain K and time constant T included in the first-order lag element of governor control unit 205 are control parameters that can be changed by a designer or an administrator. By changing these control parameter values, the operation characteristics of the virtual synchronous generator control can be changed.

FIG. 4 is a block diagram illustrating an internal configuration example of distributed power supply integration management device 101.

Referring to FIG. 4, distributed power supply integration management device 101 includes a reception unit 301, a computation unit 302, a storage unit 305, and a transmission unit 306. Using reception unit 301 and transmission unit 306, distributed power supply integration management device 101 forms communication path 109 (FIG. 1) between distributed power supply integration management device 101 and each of distributed power supplies 102 connected to power grid 104.

Reception unit 301 receives distributed power supply information 311 transmitted from each of distributed power supplies 102. For example, distributed power supply information 311 includes information about past and present operation states of distributed power supply 102, and information about a control configuration of distributed power supply 102 or constants relating to control of distributed power supply 102.

Reception unit 301 passes the received distributed power supply information to computation unit 302 as distributed power supply information 312. Reception unit 301 can generate distributed power supply information 312 by subjecting received distributed power supply information 311 to preprocessing for processing distributed power supply information 311 into the format that can be used for computation in computation unit 302.

For example, the preprocessing by reception unit 301 can include processing for converting a signal transmitted in accordance with a communication protocol into a signal format that can be processed by computation unit 302, filtering processing for removing or extracting a particular frequency band from a received time-series signal, processing for calculating the active power based on information about the output voltage and the output current of the distributed power supply, and the like. In the first embodiment, distributed power supply information 311 received by reception unit 301 includes at least information about an amplitude and a phase of the output voltage of each of distributed power supplies 102 and the output active power at present.

Storage unit 305 prestores information about configurations and connection states of distributed power supplies 102 and power grid 104 to be managed by distributed power supply integration management device 101. Furthermore, storage unit 305 passes information 319 required for processing in computation unit 302 to computation unit 302 as appropriate. In addition, storage unit 305 may update, add or delete the stored information based on information 318 from computation unit 302.

In the first embodiment, the information stored by storage unit 305 includes at least information about a connection position of each of distributed power supplies 102 and an impedance of an electrical path connecting distributed power supplies 102. For example, the information about the impedance includes a reluctance of this path. Storage unit 305 is not limited to the configuration in which storage unit 305 is provided as a component of distributed power supply integration management device 101, and may be configured to be connected to distributed power supply integration management device 101 through wireless communication or wired communication. For example, storage unit 305 can also be configured by using a cloud on the Internet.

Similarly to control device 103 shown in FIG. 2, computation unit 302 can be configured by, for example, a not-shown microcomputer including a CPU and a memory. Based on distributed power supply information 311 from reception unit 301 and information 319 received from storage unit 305, computation unit 302 can realize the below-described functions for managing each of distributed power supplies 102 by execution of a prestored program and the like.

Particularly, in the present embodiment, as to the virtual synchronous generator control implemented in each of the plurality of distributed power supplies 102, computation unit 302 determines the control contents, e.g., the configuration of the control system and the control parameter values, in each of distributed power supplies 102 such that the operation stability of power grid 104 to be managed is ensured, with consideration given to mutual interference through power grid 104. However, in the following description, the configuration of the control system is fixed to the configuration illustrated in FIG. 3, in order to simplify the description. That is, computation unit 302 appropriately sets the values of the control parameters (such as braking coefficient D, inertia constant M, and time constant T and gain K of the first-order lag system) used for the virtual synchronous generator control illustrated in FIG. 3, in order to ensure the operation stability of the grid (power grid 104) to which the plurality of distributed power supplies 102 are connected.

A management method for ensuring the operation stability of the grid will be described in detail below.

First, a problem when a plurality of distributed power supplies each implementing the virtual synchronous generator control coexist in power grid 104 will be described with reference to FIGS. 5 to 7. FIG. 5 is a block diagram illustrating a configuration example of a power system in which three distributed power supplies 102(1) to 102(3) according to a comparative example each implementing the virtual synchronous generator control coexist in a power grid to be managed.

Three distributed power supplies 102(1) to 102(3) according to the comparative example are connected to each other through a common bus 407. Each of distributed power supplies 102(1) to 102(3) implements the virtual synchronous generator control shown in FIG. 2. Reactances 404 to 406 exist between distributed power supplies 102(1) to 102(3) and common bus 407, respectively, in accordance with a wiring distance. Hereinafter, reactance values of reactances 404 to 406 are denoted as X₁ to X₃, respectively. A power supply and customer 408 other than the management target are also connected to common bus 407.

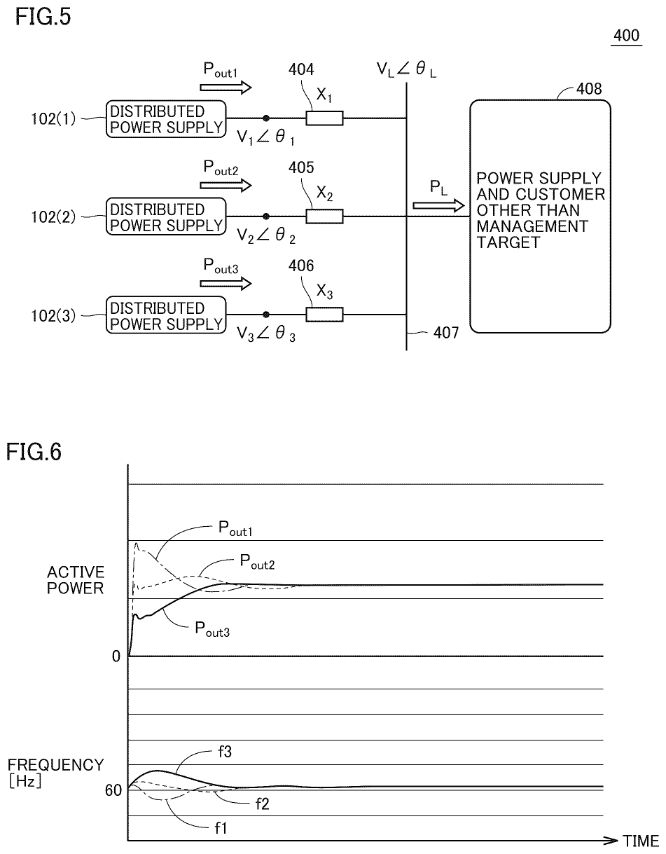

FIG. 6 is a first simulation waveform diagram of outputs of distributed power supplies 102(1) to 102(3) in the power system shown in FIG. 5. FIG. 6 shows simulation waveforms when the outputs of the distributed power supplies converge in a stable manner.

In the simulation shown in FIG. 6, for each of distributed power supplies 102(1) to 102(3), the parameters for the virtual synchronous generator control are set to M=8, D=100, K=20, and T=0.1. Furthermore, reactance values X₁ to X₃ are set to X₁=10 (%), X₂=20 (%) and X₃=40 (%) in terms of % impedance based on the ratings of the distributed power supplies.

FIG. 6 shows the simulation results of output active powers Pₒᵤₜ₁ to Pₒᵤₜ₃ of distributed power supplies 102(1) to 102(3), and frequencies f1 to f3 of the output voltages of distributed power supplies 102(1) to 102(3).

As shown in FIG. 6, even when output active powers Pₒᵤₜ₁ to Pₒᵤₜ₃ and frequencies f1 to f3 vary temporarily due to disturbance, output active powers Pₒᵤₜ₁ to Pₒᵤₜ₃ and frequencies f1 to f3 subsequently converge to constant values by the self-recovery effect provided by the virtual synchronous generator control. Therefore, it is understood that distributed power supplies 102(1) to 102(3) are operating in a stable manner.

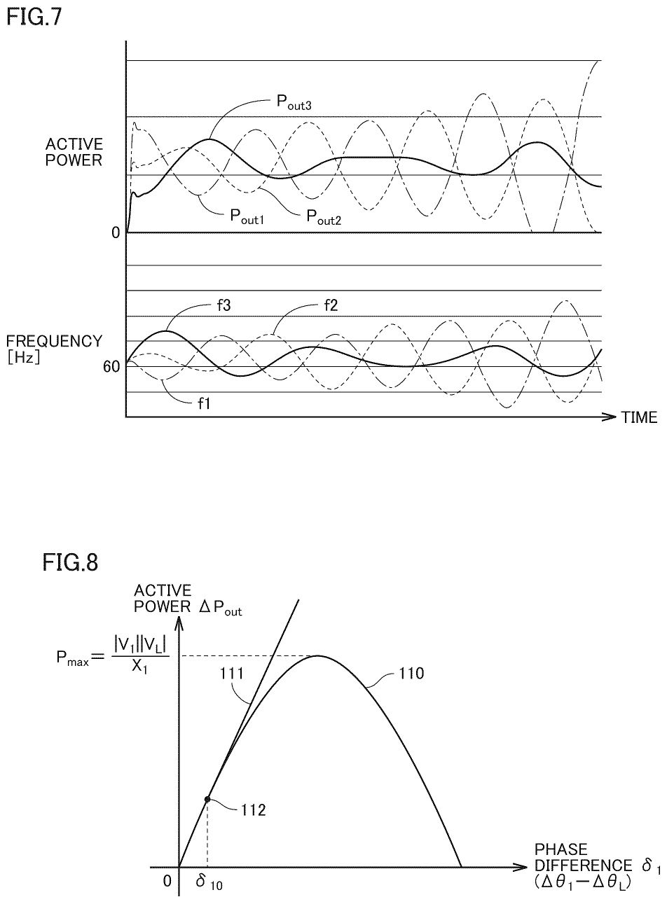

In contrast, FIG. 7 shows simulation waveforms in the case of such a divergent operation that the outputs of the distributed power supplies are unstable because the control parameter values are inappropriate.

In the simulation shown in FIG. 7, for each of distributed power supplies 102(1) to 102(3), the parameters for the virtual synchronous generator control are set to M=8, D=20, K=20, and T=0.1. In addition, reactance values X₁ to X₃ are set to X₁=10 (%), X₂=20 (%) and X₃=40 (%). That is, in the simulation shown in FIG. 7, the value of braking coefficient D in the virtual synchronous generator control in each of distributed power supplies 102(1) to 102(3) is set to be smaller, as compared with the simulation shown in FIG. 6. The remaining simulation conditions in FIG. 7 are the same as those in FIG. 6.

As shown in FIG. 7, with Pₒᵤₜ₁+Pₒᵤₜ₂+Pₒᵤₜ₃ being constant, a cross current occurs among distributed power supplies 102(1) to 102(3) in a reciprocating manner due to an influence of disturbance, and thus, output active powers Pₒᵤₜ₁ to Pₒᵤₜ₃ and frequencies f1 to f3 progress such that the oscillation expands divergently. In such a situation, distributed power supplies 102(1) to 102(3) generally deviate from their respective output limit and automatically stop.

As seen in FIGS. 6 and 7, it is understood that the operation stability of the entire power grid varies depending on the settings of the control parameters of the plurality of distributed power supplies. That is, unless the control parameter values of the virtual synchronous generator control in each of the distributed power supplies are set appropriately, it may be impossible to maintain the power grid stable.

Furthermore, since the unstable phenomenon shown in FIG. 7 occurs due to mutual interference among the plurality of distributed power supplies, it is not enough just to completely design the control parameter values for each of the distributed power supplies, and the control parameter values need to be set to take the mutual interference into consideration. In addition, the setting range of the values required for the control parameters to stabilize the operation may also vary depending on a state of other power supply and customer 408 connected to the distributed power supplies and the power grid.

In order to deal with such a problem when the plurality of distributed power supplies each implementing the virtual synchronous generator control coexist in power grid 104, the process contents in computation unit 302 of distributed power supply integration management device 101 according to the first embodiment will be described in detail.

Referring again to FIG. 4, computation unit 302 includes an operation determination unit 303 for each of distributed power supplies 102, and a control parameter determination unit 304. Operation determination unit 303 determines the necessary and sufficient number of the distributed power supplies required to be operated to supply electric power to the customer, based on the information about the present output active powers (Pₒᵤₜ in FIG. 3) of distributed power supplies 102. Furthermore, based on this determination, operation determination unit 303 generates operation start/operation stop commands for distributed power supplies 102 and determines the output active power command values (P_{ref} in FIG. 3) for distributed power supplies 102 for which the operation start commands are generated. In each of distributed power supplies 102 charged from power grid 104, output active power command value P_{ref} is set to a negative value (P_{ref}<0). There is also a case in which output active power command value P_{ref}=0 is set in distributed power supplies 102 for which the operation start commands are generated.

Hereinafter, each of patterns obtained by subdividing each of combinations (running patterns) of running/stop states of the plurality of distributed power supplies 102 connected to power grid 104 by combinations of output active power command values P_{ref} of distributed power supplies 102 in the running state will also be referred to as an operation pattern. That is, the operation pattern is changed when the running patterns (running/stop states) of the plurality of distributed power supplies are changed by operation determination unit 303, or when output active power command values P_{ref} are changed even if the running patterns are the same.

In determining the number of distributed power supplies 102 to be operated, an overview of a present demand quantity is grasped from a total value of present output active powers (Pₒᵤₜ) of distributed power supplies 102. Then, the number of distributed power supplies 102 to be operated can be determined such that at least a total of rated capacities of distributed power supplies 102 to be operated exceeds the grasped demand quantity and electric power corresponding to this demand quantity can be sufficiently supplied.

In doing so, operation determination unit 303 may determine distributed power supplies 102 to be operated, with consideration given to the operation priority of distributed power supplies 102, based on the economic and environmental cost and the operation efficiency when operating each of distributed power supplies 102. When distributed power supplies 102 for which the operation start command is generated include storage batteries, operation determination unit 303 may determine output active power command values (P_{ref}) in consideration of states of charge (SOCs) of the storage batteries.

In this way, operation determination unit 303 generates operation command information 313 including the operation start/operation stop command and output active power command value P_{ref} for each of distributed power supplies 102. Operation determination unit 303 generates latest operation command information 313 by using a lapse of a certain time period as a trigger or in response to satisfaction of a predetermined trigger condition in distributed power supply information 312. As a result, operation command information 313 is sequentially updated based on latest distributed power supply information 312. For example, the above-described trigger condition is satisfied when any one of a plurality of items constituting distributed power supply information 312 is changed.

In the first embodiment, the control configuration for the virtual synchronous generator control in each of distributed power supplies 102 is fixed to the contents shown in FIG. 3 and control parameter determination unit 304 determines the control parameter values in the control system shown in FIG. 3. In the first embodiment, under the operation pattern determined by operation determination unit 303, control parameter determination unit 304 determines the control parameter values with stability evaluation of the entire power grid, based on distributed power supply information 312 received from the reception unit and information 319 received from the storage unit.

A specific example of a method for evaluating the stability will be described below.

In the first embodiment, the operation characteristics of the power grid to be managed are expressed by a state equation and the stability is evaluated from eigenvalues of a coefficient matrix in this state equation. Here, a specific stability evaluation method will be described for the power grid including the three distributed power supplies each implementing the virtual synchronous generator control as illustrated in FIG. 5.

First, as to output active power Pₒᵤₜ₁ of first distributed power supply 102(1), and reactance value X₁ and a voltage thereacross, the relationship shown in Equation (3) below is satisfied. In Equation (3), V_{L} and θ_{L} are an amplitude and a phase of a voltage of common bus 407 at a connection point with distributed power supply 102(1), and V₁ and θ₁ are an amplitude and a phase of an output voltage of distributed power supply 102(1). In addition, Δ indicates a minute variation of each variable from a standard value in the steady stable operation state of the power grid.

$$[ Math . 3 ]$$

$$Δ {P}_{out 1} = \frac{\vert {V}_{1} \vert \vert {V}_{L} \vert}{{X}_{1}} sin ( Δ {θ}_{1} - Δ {θ}_{L} ) \qquad ( 3 )$$

Since the relationship in Equation (3) includes the non-linear characteristic, linear approximation shown in FIG. 8 is performed on the output power characteristics of the distributed power supply in order to introduce the state equation.

Referring to FIG. 8, when a phase difference in Equation (3) is denoted as (Δθ₁−Δθ_{L})=δ₁, output active power Pₒᵤₜ₁ of distributed power supply 102(1) is shown by a sin function (characteristic line 111) of phase difference δ₁ in which |V₁∥V_{L}|/X₁ in Equation (3) is a maximum value Pₘₐₓ (amplitude).

When a phase difference at an operating point 112 in the stable operation state of the power grid on characteristic line 111 is denoted as δ₁₀, a slope of a tangent line of a characteristic line 110 at operating point 112 is given by cos δ₁₀. Thus, characteristic line 111 (linear function) about variation Δ from operating point 112 that is linearly approximated near operating point 112 can be obtained. Characteristic line 111 is shown by Equation (4) below. In addition, output active powers Pₒᵤₜ₂ and Pₒᵤₜ₃ of second distributed power supply 102(2) and third distributed power supply 102(3) are also subjected to similar linear approximation about the variation from the operating point in the stable operation state, and Equations (5) and (6) can thus be obtained.

$$[ Math . 4 ]$$

$$Δ {P}_{out 1} = \frac{\vert {V}_{1} \vert \vert {V}_{L} \vert}{{X}_{1}} sin ( Δ {θ}_{1} - Δ {θ}_{L} ) \approx ( \frac{\vert {V}_{1} \vert \vert {V}_{L} \vert}{{X}_{1}} cos {δ}_{10} ) ( Δ {θ}_{1} - Δ {θ}_{L} ) = {P}_{1 m} ( Δ {θ}_{1} - Δ {θ}_{L} ) \qquad ( 4 )$$

$$Δ {P}_{out 2} = \frac{\vert {V}_{2} \vert \vert {V}_{L} \vert}{{X}_{2}} sin ( Δ {θ}_{2} - Δ {θ}_{L} ) \approx ( \frac{\vert {V}_{2} \vert \vert {V}_{L} \vert}{{X}_{2}} cos {δ}_{20} ) ( Δ {θ}_{2} - Δ {θ}_{L} ) = {P}_{2 m} ( Δ {θ}_{2} - Δ {θ}_{L} ) \qquad ( 5 )$$

$$Δ {P}_{out 3} = \frac{\vert {V}_{3} \vert \vert {V}_{L} \vert}{{X}_{3}} sin ( Δ {θ}_{3} - Δ {θ}_{L} ) \approx ( \frac{\vert {V}_{3} \vert \vert {V}_{L} \vert}{{X}_{3}} cos {δ}_{30} ) ( Δ {θ}_{3} - Δ {θ}_{L} ) = {P}_{3 m} ( Δ {θ}_{3} - Δ {θ}_{L} ) \qquad ( 6 )$$

A phase difference δ₂₀ in Equation (5) indicates a phase difference between a voltage of common bus 407 at a connection point between distributed power supply 102(2) and common bus 407 in the stable operation state and an output voltage of distributed power supply 102(2). Similarly, a phase difference δ₃₀ in Equation (6) indicates a phase difference between a voltage of common bus 407 at a connection point between distributed power supply 102(3) and common bus 407 in the stable operation state and an output voltage of distributed power supply 102(3).

In Equations (4) to (6), P₁ₘ=(|V₁∥V_{L}|/X₁)·cos δ₁₀, P₂ₘ=(|V₂∥V_{L}|/X₂)·cos δ₂₀ and P₃ₘ=(|V₃∥V_{L}|/X₃)·cos δ₃₀. P₁ₘ to P₃ₘ are coefficients that are inversely proportional to reactance values X₁ to X₃, respectively.

Furthermore, since a total of output active powers Pₒᵤₜ₁ to Pₒᵤₜ₃ of distributed power supplies 102(1) to 102(3) are equal to electric power PL flowing into power supply and customer 408 other than the management target, Equation (7) below is satisfied for variation Δ from the stable operation state.

$$[ Math . 5 ]$$

$$Δ {P}_{out 1} + Δ {P}_{out 2} + Δ {P}_{out 3} = Δ {P}_{L} \qquad ( 7 )$$

By deleting Δθ_{L} from Equations (4) to (7) and organizing Equations (4) to (7) into the matrix format, Equation (8) can be obtained.

$$[ Math . 6 ]$$

$$[ \begin{matrix}Δ {P}_{out 1} \\ Δ {P}_{out 2} \\ Δ {P}_{out 3}\end{matrix} ] = [ \begin{matrix}\frac{{P}_{1 m} ( {P}_{2 m} + {P}_{3 m} )}{{\sum }_{j = 1}^{3} {P}_{jm}} & - \frac{{P}_{1 m} {P}_{2 m}}{{\sum }_{j = 1}^{3} {P}_{jm}} & - \frac{{P}_{1 m} {P}_{3 m} )}{{\sum }_{j = 1}^{3} {P}_{jm}} \\ - \frac{{P}_{1 m} {P}_{2 m}}{{\sum }_{j = 1}^{3} {P}_{jm}} & \frac{{P}_{2 m} ( {P}_{1 m} + {P}_{3 m} )}{{\sum }_{j = 1}^{3} {P}_{jm}} & - \frac{{P}_{2 m} {P}_{3 m}}{{\sum }_{j = 1}^{3} {P}_{jm}} \\ - \frac{{P}_{1 m} {P}_{3 m}}{{\sum }_{j = 1}^{3} {P}_{jm}} & - \frac{{P}_{2 m} {P}_{3 m}}{{\sum }_{j = 1}^{3} {P}_{jm}} & \frac{{P}_{3 m} ( {P}_{1 m} + {P}_{2 m} )}{{\sum }_{j = 1}^{3} {P}_{jm}}\end{matrix} ] [ \begin{matrix}Δ {θ}_{1} \\ Δ {θ}_{2} \\ Δ {θ}_{3}\end{matrix} ] + [ \begin{matrix}\frac{{P}_{1 m}}{{\sum }_{j = 1}^{3} {P}_{jm}} \\ \frac{{P}_{2 m}}{{\sum }_{j = 1}^{3} {P}_{jm}} \\ \frac{{P}_{3 m}}{{\sum }_{j = 1}^{3} {P}_{jm}}\end{matrix} ] Δ {P}_{L} \qquad ( 8 )$$

On the other hand, the characteristics of the virtual synchronous generator control implemented in each of distributed power supplies 102(1) to 102(3) are expressed as a state equation. When the virtual synchronous generator control having the configuration shown in FIG. 3 is implemented in each of distributed power supplies 102(1) to 102(3), a transfer function is shown by Equation (9). When the transfer function of Equation (9) is re-expressed as a state equation, Equations (10) and (11) can be obtained by setting internal state variables x₁ to x₃. Internal state variable x₂ is obtained by differentiating internal state variable x₁, and internal state variable x₃ is obtained by differentiating internal state variable x₂. Equations (10) and (11) correspond to the state equation expression of the virtual synchronous generator control in one distributed power supply 102.

$$[ Math . 7 ]$$

$$\begin{matrix}{G}_{VSG} ( s ) = \frac{Δ θ}{Δ dP} = \frac{Δ θ}{Δ {P}_{ref} - Δ {P}_{out}} = \frac{Ts + 1}{{MTs}^{3} + ( M + DT ) {s}^{2} + ( D + K ) s} \\ = \frac{\frac{1}{M} s + \frac{1}{MT}}{{s}^{3} + ( \frac{1}{T} + \frac{D}{M} ) {s}^{2} + \frac{D + K}{MT} s}\end{matrix} \qquad ( 9 )$$

$$\frac{d}{dt} [ \begin{matrix}{x}_{1} \\ {x}_{2} \\ {x}_{3}\end{matrix} ] = [ \begin{matrix}0 & 1 & 0 \\ 0 & 0 & 1 \\ 0 & - \frac{D + K}{MT} & - ( \frac{1}{T} + \frac{D}{M} )\end{matrix} ] [ \begin{matrix}{x}_{1} \\ {x}_{2} \\ {x}_{3}\end{matrix} ] + [ \begin{matrix}0 \\ 0 \\ 1\end{matrix} ] Δ {P}_{ref} + [ \begin{matrix}0 \\ 0 \\ - 1\end{matrix} ] Δ {P}_{out} \qquad ( 10 )$$

$$\begin{matrix}Δ θ \\ = [ \frac{1}{MT} \frac{1}{M} 0 ] [ \begin{matrix}{x}_{1} \\ {x}_{2} \\ {x}_{3}\end{matrix} ]\end{matrix} \qquad ( 11 )$$

By integrating the three state equations of the virtual synchronous generator control, each of which is shown by Equations (10) and (11) satisfied for each of distributed power supplies 102(1) to 102(3) shown in FIG. 5, into one state equation, Equations (12) and (13) are obtained. In Equations (12) and (13), state variable xᵢⱼ indicates the j-th state variable of the i-th distributed power supply.

$$[ Math . 8 ]$$

$$\frac{d}{dt} [ \begin{matrix}{x}_{11} \\ {x}_{12} \\ {x}_{13} \\ {x}_{21} \\ {x}_{22} \\ {x}_{23} \\ {x}_{31} \\ {x}_{32} \\ {x}_{33}\end{matrix} ] = [ \begin{matrix}0 & 1 & 0 & 0 & 0 & 0 & 0 & 0 & 0 \\ 0 & 0 & 1 & 0 & 0 & 0 & 0 & 0 & 0 \\ 0 & - \frac{( {D}_{3} + {K}_{3} )}{( {M}_{3} {T}_{3} )} & - ( \frac{1}{{T}_{3}} + \frac{{D}_{3}}{{M}_{3}} ) & 0 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & - \frac{( {D}_{3} + {K}_{3} )}{( {M}_{3} {T}_{3} )} & - ( \frac{1}{{T}_{3}} + \frac{{D}_{3}}{{M}_{3}} ) & 0 & 0 & 0 \\ 0 & 0 & 0 & 0 & 0 & 0 & 0 & 1 & 0 \\ 0 & 0 & 0 & 0 & 0 & 0 & 0 & 0 & 1 \\ 0 & 0 & 0 & 0 & 0 & 0 & 0 & - \frac{( {D}_{3} + {K}_{3} )}{( {M}_{3} {T}_{3} )} & - ( \frac{1}{{T}_{3}} + \frac{{D}_{3}}{{M}_{3}} )\end{matrix} ] \qquad ( 12 )$$

$$[ \begin{matrix}{x}_{11} \\ {x}_{12} \\ {x}_{13} \\ {x}_{21} \\ {x}_{22} \\ {x}_{23} \\ {x}_{31} \\ {x}_{32} \\ {x}_{33}\end{matrix} ] + [ \begin{matrix}0 & 0 & 0 \\ 0 & 0 & 0 \\ - 1 & 0 & 0 \\ 0 & 0 & 0 \\ 0 & 0 & 0 \\ 0 & - 1 & 0 \\ 0 & 0 & 0 \\ 0 & 0 & 0 \\ 0 & 0 & - 1\end{matrix} ] [ \begin{matrix}Δ {P}_{out 1} \\ Δ {P}_{out 2} \\ Δ {P}_{out 3}\end{matrix} ] + [ \begin{matrix}0 & 0 & 0 \\ 0 & 0 & 0 \\ - 1 & 0 & 0 \\ 0 & 0 & 0 \\ 0 & 0 & 0 \\ 0 & - 1 & 0 \\ 0 & 0 & 0 \\ 0 & 0 & 0 \\ 0 & 0 & - 1\end{matrix} ] [ \begin{matrix}Δ {P}_{out 1} \\ Δ {P}_{out 2} \\ Δ {P}_{out 3}\end{matrix} ]$$

$$[ \begin{matrix}Δ {θ}_{1} \\ Δ {θ}_{2} \\ Δ {θ}_{3}\end{matrix} ] = [ \begin{matrix}\frac{1}{{M}_{1} {T}_{1}} & \frac{1}{{M}_{1}} & 0 & 0 & 0 & 0 & 0 & 0 & 0 \\ 0 & 0 & 0 & \frac{1}{{M}_{2} {T}_{2}} & \frac{1}{{M}_{2}} & 0 & 0 & 0 & 0 \\ 0 & 0 & 0 & 0 & 0 & 0 & \frac{1}{{M}_{3} {T}_{3}} & \frac{1}{{M}_{3}} & 0\end{matrix} ] [ \begin{matrix}{x}_{11} \\ {x}_{12} \\ {x}_{13} \\ {x}_{21} \\ {x}_{22} \\ {x}_{23} \\ {x}_{31} \\ {x}_{32} \\ {x}_{33}\end{matrix} ] \qquad ( 13 )$$

Finally, by integrating Equations (12) and (13) and deleting ΔPₒᵤₜ₁ to ΔPₒᵤₜ₃ and Δθ₁ to Δθ₃, Equation (14) can be obtained.

$$[ Math . 9 ]$$

$$\frac{d}{dt} [ \begin{matrix}{x}_{11} \\ {x}_{12} \\ {x}_{13} \\ {x}_{21} \\ {x}_{22} \\ {x}_{23} \\ {x}_{31} \\ {x}_{32} \\ {x}_{33}\end{matrix} ] = A [ \begin{matrix}{x}_{11} \\ {x}_{12} \\ {x}_{13} \\ {x}_{21} \\ {x}_{22} \\ {x}_{23} \\ {x}_{31} \\ {x}_{32} \\ {x}_{33}\end{matrix} ] + B [ \begin{matrix}Δ {P}_{ref 1} \\ Δ {P}_{ref 2} \\ Δ {P}_{ref 3} \\ Δ {P}_{L}\end{matrix} ] \qquad ( 14 )$$

Here, for three distributed power supplies 102(1) to 102(3), a coefficient matrix A (9 rows×9 columns) in Equation (14) is shown by Equation (15) below.

$$[ Math . 10 ]$$

$$A = [ \begin{matrix}0 & 1 & 0 & 0 & 0 & 0 & 0 & 0 & 0 \\ 0 & 0 & 1 & 0 & 0 & 0 & 0 & 0 & 0 \\ 0 & - \frac{{D}_{3} + {K}_{3}}{{M}_{3} {T}_{3}} & - ( \frac{1}{{T}_{3}} + \frac{{D}_{3}}{{M}_{3}} ) & 0 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & - \frac{{D}_{3} + {K}_{3}}{{M}_{3} {T}_{3}} & - ( \frac{1}{{T}_{3}} + \frac{{D}_{3}}{{M}_{3}} ) & 0 & 0 & 0 \\ 0 & 0 & 0 & 0 & 0 & 0 & 0 & 1 & 0 \\ 0 & 0 & 0 & 0 & 0 & 0 & 0 & 0 & 1 \\ 0 & 0 & 0 & 0 & 0 & 0 & 0 & - \frac{{D}_{3} + {K}_{3}}{{M}_{3} {T}_{3}} & - ( \frac{1}{{T}_{3}} + \frac{{D}_{3}}{{M}_{3}} )\end{matrix} ] + \qquad ( 15 )$$

$$[ \begin{matrix}0 & 0 & 0 & 0 & 0 & 0 & 0 & 0 & 0 \\ 0 & 0 & 0 & 0 & 0 & 0 & 0 & 0 & 0 \\ - \frac{{P}_{1 m} ( {P}_{2 m} + {P}_{3 m} )}{( {\sum }_{j = 1}^{3} {P}_{jm} )} \frac{1}{{M}_{1} {T}_{1}} & - \frac{{P}_{1 m} ( {P}_{2 m} + {P}_{3 m} )}{( {\sum }_{j = 1}^{3} {P}_{jm} )} \frac{1}{{M}_{1}} & 0 & \frac{{P}_{1 m} {P}_{2 m}}{{\sum }_{j = 1}^{3} {P}_{jm}} \frac{1}{{M}_{2} {T}_{2}} & \frac{{P}_{1 m} {P}_{2 m}}{{\sum }_{j = 1}^{3} {P}_{jm}} \frac{1}{{M}_{2}} & 0 & \frac{{P}_{1 m} {P}_{3 m}}{{\sum }_{j = 1}^{3} {P}_{jm}} \frac{1}{{M}_{3} {T}_{3}} & \frac{{P}_{1 m} {P}_{3 m}}{{\sum }_{j = 1}^{3} {P}_{jm}} \frac{1}{{M}_{3}} & 0 \\ 0 & 0 & 0 & 0 & 0 & 0 & 0 & 0 & 0 \\ 0 & 0 & 0 & 0 & 0 & 0 & 0 & 0 & 0 \\ \frac{{P}_{1 m} {P}_{2 m}}{{\sum }_{j = 1}^{3} {P}_{jm}} \frac{1}{{M}_{1} {T}_{1}} & \frac{{P}_{1 m} {P}_{2 m}}{{\sum }_{j = 1}^{3} {P}_{jm}} \frac{1}{{M}_{1}} & 0 & - \frac{{P}_{2 m} ( {P}_{1 m} + {P}_{3 m} )}{( {\sum }_{j = 1}^{3} {P}_{jm} )} \frac{1}{{M}_{2} {T}_{2}} & - \frac{{P}_{2 m} ( {P}_{1 m} + {P}_{3 m} )}{( {\sum }_{j = 1}^{3} {P}_{jm} )} \frac{1}{{M}_{2}} & 0 & \frac{{P}_{2 m} {P}_{3 m}}{{\sum }_{j = 1}^{3} {P}_{jm}} \frac{1}{{M}_{3} {T}_{3}} & \frac{{P}_{2 m} {P}_{3 m}}{{\sum }_{j = 1}^{3} {P}_{jm}} \frac{1}{{M}_{3}} & 0 \\ 0 & 0 & 0 & 0 & 0 & 0 & 0 & 0 & 0 \\ 0 & 0 & 0 & 0 & 0 & 0 & 0 & 0 & 0 \\ \frac{{P}_{1 m} {P}_{3 m}}{{\sum }_{j = 1}^{3} {P}_{jm}} \frac{1}{{M}_{1} {T}_{1}} & \frac{{P}_{1 m} {P}_{3 m}}{{\sum }_{j = 1}^{3} {P}_{jm}} \frac{1}{{M}_{1}} & 0 & \frac{{P}_{2 m} {P}_{3 m}}{{\sum }_{j = 1}^{3} {P}_{jm}} \frac{1}{{M}_{2} {T}_{2}} & \frac{{P}_{2 m} {P}_{3 m}}{{\sum }_{j = 1}^{3} {P}_{jm}} \frac{1}{{M}_{2}} & 0 & - \frac{{P}_{3 m} ( {P}_{1 m} + {P}_{2 m} )}{( {\sum }_{j = 1}^{3} {P}_{jm} )} \frac{1}{{M}_{3} {T}_{3}} & - \frac{{P}_{3 m} ( {P}_{1 m} + {P}_{2 m} )}{( {\sum }_{j = 1}^{3} {P}_{jm} )} \frac{1}{{M}_{3}} & 0\end{matrix} ]$$

Similarly, a matrix B (9 rows×4 columns) in Equation (14) is shown by Equation (16) below.

$$[ Math . 11 ]$$

$$B = [ \begin{matrix}0 & 0 & 0 & 0 \\ 0 & 0 & 0 & 0 \\ 1 & 0 & 0 & - \frac{{P}_{1 m}}{{\sum }_{j = 1}^{3} {P}_{jm}} \\ 0 & 0 & 0 & 0 \\ 0 & 0 & 0 & 0 \\ 0 & 1 & 0 & - \frac{{P}_{2 m}}{{\sum }_{j = 1}^{3} {P}_{jm}} \\ 0 & 0 & 0 & 0 \\ 0 & 0 & 0 & 0 \\ 0 & 0 & 1 & - \frac{{P}_{3 m}}{{\sum }_{j = 1}^{3} {P}_{jm}}\end{matrix} ] \qquad ( 16 )$$

Equation (14) is a state equation expression including all of the operation characteristics of the power grid to be managed. By obtaining eigenvalues of coefficient matrix A (Equation (15)) in Equation (14), an oscillation mode of the grid can be grasped.

Generally, a negative real part of the eigenvalues of coefficient matrix A indicates an attenuation rate of the oscillation of the system, whereas a positive real part of the eigenvalues of coefficient matrix A indicates a divergence rate of the oscillation. In addition, an imaginary part of the eigenvalues indicates a frequency of the oscillation.

Therefore, when the eigenvalues of coefficient matrix A in Equation (14) are obtained and all of the obtained eigenvalues have negative real parts, it can be confirmed that the oscillation occurring in this grid is in an attenuation direction and stable. That is, the negative absolute values of the real parts of the eigenvalues can be used as a stability index for evaluating the stability of the power grid.

As described above, in the present embodiment, linear approximation is practically used in the derivation process, which causes a difference between the characteristics obtained from the above-described state equation and the actual operation characteristics of the power grid. Therefore, in order to stabilize the operation of the power grid, it is desirable that all of the eigenvalues of coefficient matrix A should have negative real parts and the absolute values of the real parts should be equal to or larger than a certain threshold value.

As an example, when the main eigenvalues of coefficient matrix A described above are derived for the grid including three distributed power supplies 102(1) to 102(3) as illustrated in FIG. 5, the main eigenvalues are “−11.21523±4.86337i”, “−11.221523±4.8632377i”, “−11.237589±4.8508335i”, and “−11.25±4.8412292i” in the case of the setting conditions in the simulation results shown in FIG. 6 (stable operation).

The main eigenvalues are “−6.1625308±3.2739828i”, “−6.2123889±3.2929444i” and “−6.25±3.3071891i” in the case of the setting conditions in the simulation results shown in FIG. 7 (unstable operation).

When these are compared, it can be confirmed that although all of the main eigenvalues have negative real parts both in the case shown in FIG. 6 and in the case shown in FIG. 7, the absolute values of the real parts (negative values) are larger in the case shown in FIG. 6. For example, in order to separate the stable operation shown in FIG. 6 from the unstable operation shown in FIG. 7, the control parameter values are set such that the absolute values of the real parts (negative values) of the eigenvalues are equal to or larger than 11, which makes it possible to ensure the stable operation of the power grid. Since an appropriate value of the threshold value may vary depending on the grid configuration, it is desirable to predefine the appropriate value based on instantaneous value simulation or the like.

As described above, the stability of the power grid can be evaluated by calculating the eigenvalues of coefficient matrix A in the state equation. Here, coefficient matrix A shown in Equation (15) is an example when three distributed power supplies 102(1) to 102(3) operate in accordance with the virtual synchronous generator control, and coefficient matrix A shown in Equation (15) has the size of (3×3) rows×(3×3) columns. However, the size of coefficient matrix A varies depending on the number (N: natural number) of the distributed power supplies operating in a state of being connected to the power grid. Specifically, the size of coefficient matrix A for the number N of the distributed power supplies for which the operation start command is generated is (N×3) rows×(N×3) columns.

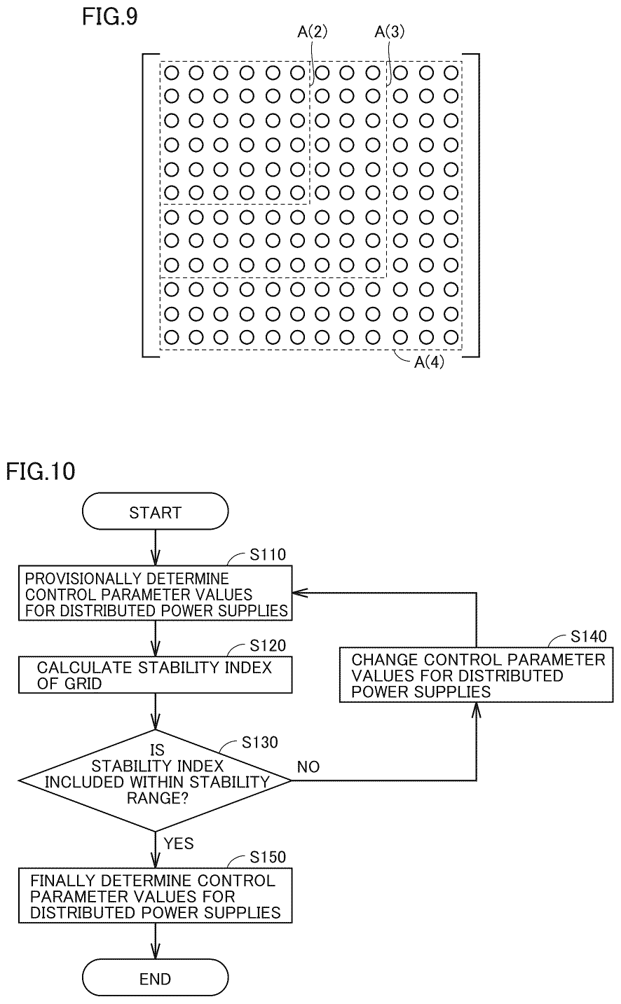

As shown in FIG. 9, a coefficient matrix A(2) when N=2 has the size of 6 rows×6 columns because 3×2=6. As also shown in Equation (15), a coefficient matrix A(3) when N=3 has the size of 9 rows×9 columns. A coefficient matrix A(4) when N=4 has the size of 12 rows×12 columns because 4×3=12.

When a combination of the distributed power supplies to be operated varies even if the number (N) of the distributed power supplies operating in accordance with the virtual synchronous generator control is the same, coefficient matrix A also varies mainly due to a difference in reactance values X₁ to X₃. In addition, when the output active power command values of the distributed power supplies to be operated vary, operating point 112 (stable operation state) in FIG. 8 varies, and thus, coefficient matrix A may also vary.

Therefore, coefficient matrix A used for stability evaluation may vary every time the operation start/operation stop command for each of distributed power supplies 102 and output active power command value P_{ref} for each of distributed power supplies 102, i.e., the operation patterns are changed by operation determination unit 303 shown in FIG. 3. In response to this, stability evaluation is also preferably performed again.

FIG. 10 shows a flowchart illustrating an example of a procedure of a process of determining the control parameter values in the distributed power supply integration management device according to the first embodiment. The process shown in FIG. 10 is performed at least when the running patterns (combinations of running/stop states) of the plurality of distributed power supplies are changed by operation determination unit 303, e.g., when the microcomputer constituting computation unit 302 executes a prestored program. The function of control parameter determination unit 304 shown in FIG. 4 is thus realized.

Alternatively, even if the operation patterns of the plurality of distributed power supplies are fixed, the process shown in FIG. 10 may also be performed when output active power command values P_{ref} of the plurality of distributed power supplies are changed. That is, the process shown in FIG. 10 can be triggered by the change in the operation patterns of the plurality of distributed power supplies 102 by operation determination unit 303.

In step (hereinafter, simply denoted as “S”) 110, computation unit 302 (control parameter determination unit 304) provisionally determines the control parameter values for each of the distributed power supplies. For example, for each of the distributed power supplies to be operated, the values of inertia constant M, braking coefficient D, and gain K and time constant T of the first-order lag element constituting governor control unit 205 in virtual synchronous generator control unit 201 illustrated in FIG. 3 are provisionally determined. The initial values of the provisionally determined control parameter values may be predetermined standard values, or may be randomly set values. Furthermore, in S110, the coefficient matrix in Equation (15) is also provisionally determined using the provisionally determined control parameter values.

In S120, computation unit 302 calculates the stability index of the grid using coefficient matrix A determined provisionally in S110. For example, the eigenvalues of coefficient matrix A are calculated as described above. Then, in S130, computation unit 302 determines whether the stability index (eigenvalues of coefficient matrix A) calculated in S120 is included within a predetermined stability range. For example, when all of the eigenvalues have negative real parts and the absolute values of the real parts are larger than the predetermined threshold value as described above, the determination is YES in S130. Otherwise, the determination is NO in S130.

When the determination is NO in S130, computation unit 302 changes at least a part of the control parameter values in S140. In S140, braking coefficient D and/or inertia constant M are, for example, increased in certain increments (certain amount or certain ratio) in at least a part of the distributed power supplies in order to increase the stability of the grid. When increasing braking coefficient D and inertia constant M does not lead to sufficient improvement of the stability index, gain K can be further increased.

Furthermore, computation unit 302 returns the process to S110 and provisionally determines coefficient matrix A corrected using the control parameter values changed in S140. Then, in S120, the stability index of the grid is calculated using corrected coefficient matrix A. In S130, it is determined whether the stability index (eigenvalues of corrected coefficient matrix A) calculated in S120 is included within the range where the stability is ensured.

While the determination is NO in S130, the processing in S140, S110, S120, and S130 is repeatedly performed. That is, until the control parameter values that cause determination of YES in S130 are set, the control parameter values are gradually changed in S140.

When the determination is YES in S130, computation unit 302 finally determines, in S150, the control parameter values for virtual synchronous generator control unit 201 of each of the distributed power supplies for which the operation start command is generated, using the values determined provisionally in S110.

As a result, the control parameter values that allow the grid to operate in a stable manner can be determined to correspond to operation command information 313 determined by operation determination unit 303, and specifically the operation start/operation stop command and output active power command value P_{ref} for each of distributed power supplies 102.

Referring again to FIG. 4, computation unit 302 outputs operation command information 313 (the operation start/operation stop command and output active power command value P_{ref} for each of distributed power supplies 102) determined by operation determination unit 303 and information 314 (control parameter values for allowing the grid to operate in a stable manner) determined by control parameter determination unit 304 to correspond to operation command information 313 to transmission unit 306 as setting information 315. In doing so, computation unit 302 may pass information 318 to storage unit 305 for storage. This information 317 may include at least a part of the information output to transmission unit 306.

When transmission unit 306 receives setting information 315 from computation unit 302, transmission unit 306 transmits the operation command value and the control parameter values for each of distributed power supplies 102 to each of distributed power supplies 102. As described above, in the first embodiment, setting information 315 includes at least the operation start/operation stop command and the output active power command value for each of distributed power supplies 102 (operation command information 313), and the control parameter values for the virtual synchronous generator control implemented in each of distributed power supplies 102 for which the operation start command is generated.

As described above, according to the distributed power supply integration management device of the first embodiment, even in the case of a power grid to which a plurality of distributed power supplies whose output voltages are controlled by virtual synchronous generator control are connected, control parameter values for the virtual synchronous generator control in each of the distributed power supplies are appropriately set such that an unstable phenomenon caused by mutual interference among the distributed power supplies does not occur when an operation pattern of each of the distributed power supplies is changed. This makes it possible to realize the operation with ensured stability, and to avoid the occurrence of an unstable phenomenon caused by mutual interference of control among the plurality of distributed power supplies, and realize stable power supply.

### Second Embodiment

In the first embodiment, the stability index is calculated by obtaining the eigenvalues of coefficient matrix A in the state equation. However, in a second embodiment, a different method for calculating the stability index will be described. Specifically, a distributed power supply integration management device according to the second embodiment is different from distributed power supply integration management device 101 according to the first embodiment only in terms of the function of control parameter determination unit 304. Since the configuration and operation of the remaining portions of the distributed power supply integration management device according to the second embodiment are the same as those of distributed power supply integration management device 101 according to the first embodiment, detailed description will not be repeated.

In the second embodiment, control parameter determination unit 304 derives an open-loop transfer function indicating a frequency response of a power grid when evaluating the stability of the grid. Control parameter determination unit 304 can evaluate the stability of the grid in S130 (FIG. 9) using a phase margin and a gain margin of the open-loop transfer function as a stability index (S120 in FIG. 9).

In the second embodiment as well, the power grid to which the three distributed power supplies whose output voltages are controlled by the virtual synchronous generator control are connected as illustrated in FIG. 5 is used to describe a method for evaluating the stability using the open-loop transfer function.

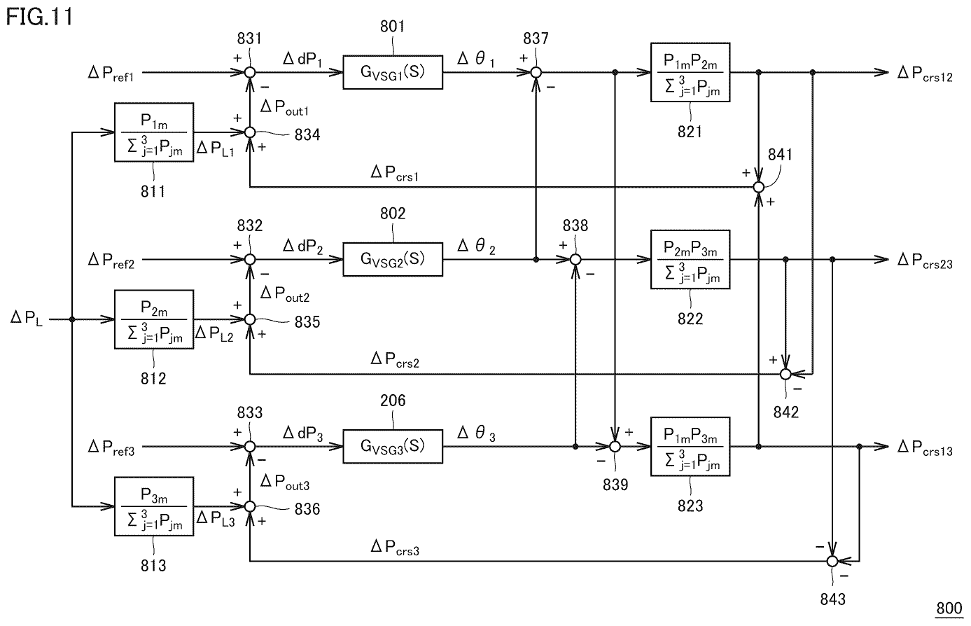

FIG. 11 is an example of a block diagram showing control transfer characteristics of the power grid including transfer functions used in the distributed power supply integration management device according to the second embodiment. FIG. 11 shows a control transfer block diagram, with consideration given to interference of the virtual synchronous generator control in three distributed power supplies 102(1) to 102(3) in the power grid illustrated in FIG. 5.

In FIG. 11, above-described minute variation Δ is introduced into each of active power P_{L} on common bus 407, and output power command values P_{ref1} to P_{ref3}, output active powers (measurement values) Pₒᵤₜ₁ to Pₒᵤₜ₃, and phases θ₁ to θ₃ of the output voltages of distributed power supplies 102(1) to 102(3).

Here, for the power grid illustrated in FIG. 5, Equation (8) is satisfied by linear approximation described in the first embodiment. The output voltages of distributed power supplies 102(1) to 102(3) are controlled by the virtual synchronous generator control having the configuration shown in FIG. 3. Therefore, using transfer functions G_{VSG1}(s) to G_{VSG3}(s) of the virtual synchronous generator control in distributed power supplies 102(1) to 430, the transfer characteristics of the power grid having distributed power supplies 102(1) to 102(3) connected thereto are shown by the block diagram in FIG. 11, with cross currents (mutual interference) occurring among distributed power supplies 102(1) to 102(3) being reflected. Transfer functions G_{VSG1}(s) to G_{VSG3}(s) of distributed power supplies 102(1) to 102(3) can be obtained by substituting control parameter values D, M, T, and K into Equation (9).

In FIG. 11, a cross current ΔP_{crs12} from distributed power supply 102(1) to distributed power supply 102(2), a cross current ΔP_{crs23} from distributed power supply 102(2) to distributed power supply 102(3), and a cross current ΔP_{crs13} from distributed power supply 102(1) to distributed power supply 102(3) are input to arithmetic units 841 to 843 for addition and subtraction, whereby total values ΔP_{crs1} to ΔP_{crs3} of the cross currents in distributed power supplies 102(1) to 102(3) can be obtained.

In addition, an active power variation ΔP_{L} on common bus 407 is proportionally divided into ΔP_{L1} to ΔP_{L3} among distributed power supplies 102(1) to 102(3) (ΔP_{L1}+ΔP_{L2}+ΔP_{L3}=ΔP_{L}) as a result of the computation in multipliers 811 to 813 based on constants P₁ₘ to P₃ₘ in Equations (4) to (6). Adders 834 to 836 add ΔP_{L1} to ΔP_{L3} from multipliers 811 to 813 and ΔP_{crs1} to ΔP_{crs3} from arithmetic units 841 to 843, respectively, to calculate output active power variations ΔPₒᵤₜ₁ to ΔPₒᵤₜ₃ in distributed power supplies 102(1) to 102(3), respectively.

Subtractors 831 to 833 subtract ΔPₒᵤₜ₁ to ΔPₒᵤₜ₃ from adders 834 to 836 from output active power command value variations ΔP_{ref1} to ΔP_{ref3}, to calculate variations ΔdP₁ to dP₃ of power deviation ΔPₒᵤₜ (FIG. 3) in distributed power supplies 102(1) to 102(3), respectively.

An open-loop transfer function G(1) starting from ΔdP₁ is obtained in accordance with the control transfer characteristics shown in FIG. 11, whereby frequency response characteristics can be grasped, with consideration given to interference between the virtual synchronous generator control in distributed power supply 102(1) and the virtual synchronous generator control in the other distributed power supplies 102(2) and 102(3).

Similarly, an open-loop transfer function G(2) starting from ΔdP₂ and an open-loop transfer function G(3) starting from ΔdP₃ are obtained, whereby frequency response characteristics can also be grasped, with consideration given to interference between the virtual synchronous generator control in distributed power supplies 102(2) and 102(3) and the virtual synchronous generator control in another distributed power supply.

Such derivation of the open-loop transfer functions is a commonly used technique and these open-loop transfer functions can be obtained by applying a known method. It is preferable to derive the format of these open-loop transfer functions in advance based on the number of the distributed power supplies to be operated and the configuration information of the virtual synchronous generator control unit.

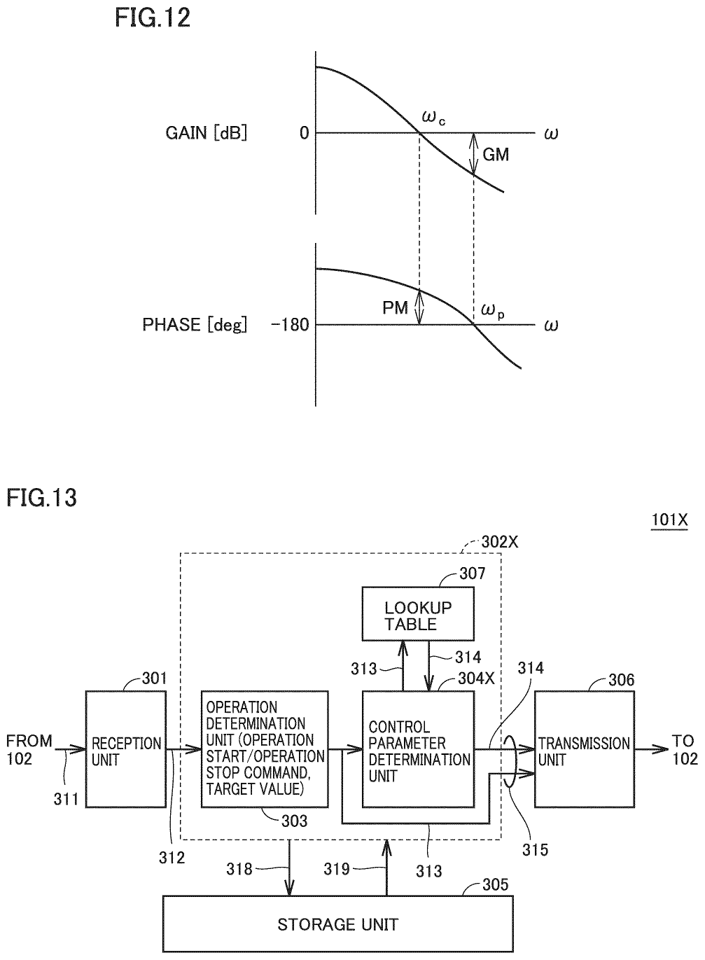

Furthermore, a gain margin GM and a phase margin PM shown in FIG. 12 can be further obtained from Bode plots of the obtained open-loop transfer functions in accordance with the known technique.

As shown in FIG. 12, a Bode plot indicating frequency characteristics of an open-loop transfer function is obtained for a gain [dB] and a phase [deg]. Gain margin GM is defined as a phase [deg] at a frequency ω_{c} when the gain is 0 [dB], and phase margin PM is defined as a (−1) multiple of a gain at a frequency ωₚ when the phase is −180 [deg]. It is common to use gain margin GM and phase margin PM as the stability index when designing a control system, and it is known that as gain margin GM and phase margin PM become larger, the system becomes more stable.

Therefore, in the distributed power supply integration management device according to the second embodiment, when the operation patterns of the plurality of distributed power supplies 102 are changed and computation unit 302 (control parameter determination unit 304) performs the process shown in FIG. 9, above-described open-loop transfer functions G(1) to G(3) are obtained in S110, using transfer functions G_{VSG1}(s) to G_{VSG3}(s) into which the provisionally determined control parameter values are substituted.

Furthermore, in S120 in FIG. 10, gain margin GM and phase margin PM from open-loop transfer functions G(1) to G(3) determined in S110 are calculated as the stability index. Furthermore, in S130 in FIG. 10, when gain margin GM and phase margin PM calculated in S120 are larger than predetermined determination threshold values TH_{GM} and TH_{PM}, respectively, it can be determined that the stability index is included within the stability range (determination of YES).

When the determination is NO in S130, transfer functions G_{VSG1}(s) to G_{VSG3}(s) and open-loop transfer functions G(1) to G(3) are changed by changing the control parameter values for the virtual synchronous generator control in S140, and S120 and S130 are performed. S140 and S110 to S130 are repeated until the determination of YES is made in S130. As a result, similarly to the first embodiment, the control parameter values that allow the grid to operate in a stable manner can be determined to correspond to the operation patterns of the plurality of distributed power supplies 102 determined by operation determination unit 303.

Above-described determination threshold values TH_{GM} and TH_{PM} of gain margin GM and phase margin PM can also be set in advance in light of the results in circuit simulation and the stability determination results based on the Bode plots.

As described above, according to the distributed power supply integration management device of the second embodiment, the frequency response characteristics of the transfer functions obtained from the control parameter values (virtual synchronous generator control) are used as the stability index, whereby the same effects as those of the first embodiment can be achieved. That is, even in the case of a power grid to which a plurality of distributed power supplies whose output voltages are controlled by virtual synchronous generator control are connected, control parameter values for the virtual synchronous generator control can be appropriately set such that an unstable phenomenon caused by mutual interference among the distributed power supplies does not occur when an operation pattern of each of the distributed power supplies is changed. This makes it possible to avoid the occurrence of an unstable phenomenon caused by mutual interference of control among the plurality of distributed power supplies, and realize stable power supply.

### Third Embodiment

In third and fourth embodiments, further modifications of the distributed power supply integration management device will be described.

FIG. 13 is a block diagram illustrating an internal configuration of a distributed power supply integration management device according to the third embodiment.

Referring to FIG. 13, a distributed power supply integration management device 101X according to the third embodiment is different from distributed power supply integration management device 101 shown in FIG. 4 in that distributed power supply integration management device 101X includes a computation unit 302X instead of computation unit 302. Since the remaining configuration of distributed power supply integration management device 101X is the same as the configuration of distributed power supply integration management device 101, detailed description will not be repeated.

Computation unit 302X further includes operation determination unit 303, a control parameter determination unit 304X and a lookup table 307. As described with reference to FIG. 4, operation determination unit 303 generates operation command information 313 based on distributed power supply information 312 such as the present output active power (Pₒᵤₜ in FIG. 3) of each of distributed power supplies 102. As described above, operation command information 313 includes the operation start/operation stop command and output active power command value P_{ref} for each of distributed power supplies 102.

Unlike the first and second embodiments in which the stability index calculated using the provisionally determined control parameter values is evaluated, control parameter determination unit 304X refers to preliminarily created lookup table 307 and determines the control parameter values (such as braking coefficient D, inertia constant M, and time constant T and gain K of the first-order lag system) used for the virtual synchronous generator control in distributed power supplies 102 for which the operation start command is generated.

Lookup table 307 is configured to prestore the control parameter values (combinations of the values of D, M, T, and K described above) that allow the grid to operate in a stable manner, for each of the operation patterns of the plurality of distributed power supplies 102 connected to power grid 104. These control parameter values are obtained in advance from a simulation result and the like. For example, for each of the operation patterns of the plurality of distributed power supplies 102, lookup table 307 stores the control parameter values for which it is analyzed in advance that the stability index is included within the stability range in accordance with the first and second embodiments.

Control parameter determination unit 304X selects one of the plurality of predefined operation patterns based on operation command information 313 from operation determination unit 303, and refers to lookup table 307. As a result, the prestored control parameter values that allow the grid to operate in a stable manner can be read from lookup table 307 in accordance with the operation pattern determined by operation command information 313. These control parameter values are output to transmission unit 306 as a part of information 314 from control parameter determination unit 304X together with operation command information 313, and transmitted to each of distributed power supplies 102.

As described above, according to the distributed power supply integration management device of the third embodiment as well, control parameter values for virtual synchronous generator control can be appropriately set such that an unstable phenomenon caused by mutual interference among distributed power supplies does not occur when an operation pattern of each of the distributed power supplies is changed. This makes it possible to avoid the occurrence of an unstable phenomenon caused by mutual interference of control among the plurality of distributed power supplies, and realize stable power supply.

In the first and second embodiments, the computation load is relatively high because calculation and evaluation of the stability index using the provisionally determined control value parameter values are performed online. However, in the third embodiment, such an increase in computation load online can be avoided. On the other hand, in the third embodiment, it is necessary to predetermine the appropriate control parameter values for each of the operation patterns of the plurality of distributed power supplies 102, which arouses concern about an increase in storage capacity of lookup table 307 and workload for preparation of lookup table 307.

### Fourth Embodiment

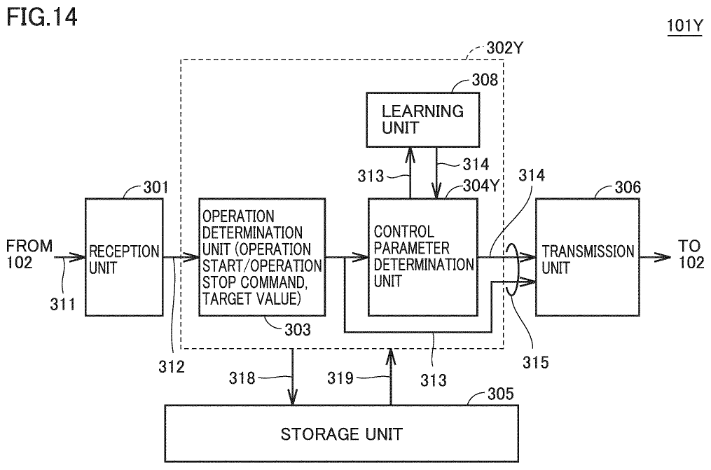

FIG. 14 is a block diagram illustrating an internal configuration of a distributed power supply integration management device according to the fourth embodiment.

Referring to FIG. 14, a distributed power supply integration management device 101Y according to the fourth embodiment is different from distributed power supply integration management device 101 shown in FIG. 4 in that distributed power supply integration management device 101Y includes a computation unit 302Y instead of computation unit 302. Since the remaining configuration of distributed power supply integration management device 101Y is the same as the configuration of distributed power supply integration management device 101, detailed description will not be repeated.

Computation unit 302Y is different in that computation unit 302Y includes operation determination unit 303, a control parameter determination unit 304Y and a learning unit 308. As described with reference to FIG. 4, operation determination unit 303 generates operation command information 313 based on distributed power supply information 312 such as the present output active power (Pₒᵤₜ in FIG. 3) of each of distributed power supplies 102. As described above, operation command information 313 includes the operation start/operation stop command and output active power command value P_{ref} for each of distributed power supplies 102.

Unlike the first and second embodiments in which the stability index is evaluated using the provisionally determined control parameter values, control parameter determination unit 304Y reflects a result of learning in learning unit 308 and determines the control parameter values (such as braking coefficient D, inertia constant M, and time constant T and gain K of the first-order lag system) used for the virtual synchronous generator control in distributed power supplies 102 for which the operation start command is generated.

Learning unit 308 includes, for each of the operation patterns, a learning model that uses a combination of the control parameter values as an input and uses stability evaluation (information of being stable/unstable, or the stability index in the first and second embodiments) under this combination of the control parameter values as an output. For example, this learning model can be configured by an artificial intelligence (AI) learning model.

As an example, this learning model can be created for each of the operation patterns by machine learning that inputs, as learning data, a correspondence relationship between a combination of the control parameter values and a result of stability evaluation when using this combination of the control parameter values. In creating the learning model (learning phase), the result of stability evaluation can include both a result when the power system is actually operated and a simulation result.

In an inference phase, the learning model is configured to use the operation pattern as an input and use an appropriate combination of the control parameter values (D, M, T, and K) as an output. A combination that causes positive stability evaluation in this operation pattern, or a combination that makes the stability index larger than the predetermined threshold value in this operation pattern can be used as the appropriate combination of the control parameter values.

Control parameter determination unit 304Y inputs the operation pattern indicated by operation command information 313 from operation determination unit 303 to the learning model constituting learning unit 308. As a result, the appropriate combination of the control parameter values in this operation determination pattern is obtained as an output of the learning model.

These control parameter values are output to transmission unit 306 as a part of information 314 from control parameter determination unit 304Y together with operation command information 313, and transmitted to each of distributed power supplies 102.

Control parameter determination unit 304Y can also sequentially update the learning model in learning unit 308 by additionally inputting a new result obtained when the power system is actually operated to learning unit 308 as learning data.

As described above, according to the distributed power supply integration management device of the fourth embodiment as well, control parameter values for virtual synchronous generator control can be appropriately set such that an unstable phenomenon caused by mutual interference among distributed power supplies does not occur when an operation pattern of each of the distributed power supplies is changed. This makes it possible to avoid the occurrence of an unstable phenomenon caused by mutual interference of control among the plurality of distributed power supplies, and realize stable power supply. In the fourth embodiment, there is no need to prepare and store lookup table 307 described in the third embodiment, and thus, a reduction in workload and storage capacity can be expected.

As described above, in the first to fourth embodiments, control parameter determination unit 304 (304X, 304Y) determines the control parameter values in FIG. 3, assuming that the configuration of the control system of the virtual synchronous generator control in each of distributed power supplies 102 is fixed to the contents shown in FIG. 3. However, the configuration of the control system of the virtual synchronous generator control may be switched in accordance with the operation setting pattern. For example, a configuration in which the feedback loop of governor control unit 205 (first-order lag system) is omitted in FIG. 3 (modification) may be applied to some operation patterns. For example, the above-described configuration (modification) can be realized by setting gain K of the first-order lag system to K=0. That is, the function of control parameter determination unit 304 (304X, 304Y) also substantially includes determining the configuration of the control system of the virtual synchronous generator control.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

10 power system; 101, 101X, 101Y distributed power supply integration management device; 102, 102a to 102f distributed power supply; 103 control device; 104 power grid; 105 power supply; 106 power conversion device; 107 main circuit; 108 switching control circuit; 109 communication path; 110, 111 characteristic line; 112 operating point; 200 distributed power supply control unit; 201 virtual synchronous generator control unit; 202 operation command value generation unit; 203, 203b, 208 integrator; 204 feedback path; 205 governor control unit; 206, 811, 813 multiplier; 211 to 213, 831, 833 subtractor; 214, 834, 836 adder; 301 reception unit; 302, 302X, 302Y computation unit; 303 operation determination unit; 304, 304X, 304Y control parameter determination unit; 305 storage unit; 306 transmission unit; 307 lookup table; 308 learning unit; 311, 312 distributed power supply information; 313 operation command information; 314, 317, 318, 319 information; 315 setting information; 404, 406, X1 reactance; 407 common bus; 841, 843 arithmetic unit; D, K, M, T control parameter value; GM gain margin; G_{VSG1} to G_{VSG1} transfer function; PM phase margin; Pₒᵤₜ, Pₒᵤₜ₁ to Pₒᵤₜ₃ output active power (measurement value); P_{ref}, P_{ref1} to P_{ref3} output active power command value; X₁ to X₃ reactance value; Δf frequency change amount; f frequency command value; fn reference frequency; θ voltage phase.

1. A distributed power supply integration management device that manages a usage state of a power grid having a plurality of distributed power supplies connected thereto, output voltages of the plurality of distributed power supplies being controlled by virtual synchronous generator control that implements operation characteristics of a synchronous generator in a static power supply in a simulative manner, the distributed power supply integration management device comprising:
a reception circuit to receive information about an operation state of each of the plurality of distributed power supplies;
an operation determination circuit to determine an operation pattern of the plurality of distributed power supplies based on the information obtained by the reception circuit;
a control parameter determination circuit to, in the operation pattern determined by the operation determination circuit, determine a control parameter value for the virtual synchronous generator control in each of the plurality of distributed power supplies, such that mutual interference of the virtual synchronous generator control in the plurality of distributed power supplies can be avoided and the power grid can operate in a stable manner; and
a transmission circuit to transmit, to each of the plurality of distributed power supplies, an operation command corresponding to the operation pattern determined by the operation determination circuit and the control parameter value determined by the control parameter determination circuit.

2. The distributed power supply integration management device according to claim 1, wherein
the control parameter determination circuit calculates a value of a stability index quantitatively indicating operation stability of the power grid when the virtual synchronous generator control is performed using the control parameter value determined provisionally, and determines whether the calculated value of the stability index is included within a predetermined stability range, and
when the calculated value of the stability index is included within the stability range, the control parameter determination circuit determines the control parameter value to be transmitted to each of the plurality of distributed power supplies, using the provisionally determined control parameter value.

3. The distributed power supply integration management device according to claim 2, wherein
when the value of the stability index calculated using the provisionally determined control parameter value is not included within the stability range, the control parameter determination circuit repeats a process of changing the control parameter value and calculating the stability index, until the calculated value of the stability index is included within the stability range.

4. The distributed power supply integration management device according to claim 2, wherein
the stability index is a value of a real part of an eigenvalue of a coefficient matrix in a state equation, the state equation expressing operation characteristics of the power grid to which the virtual synchronous generator control in the plurality of distributed power supplies is applied.

5. The distributed power supply integration management device according to claim 2, wherein
the stability index is at least one of a phase margin and a gain margin of an open-loop transfer function derived using a transfer function in the power grid, the transfer function expressing operation characteristics of the power grid and operation characteristics of the virtual synchronous generator control of each of the plurality of distributed power supplies, and
the open-loop transfer function is derived by regarding the virtual synchronous generator control of any one distributed power supply of the plurality of distributed power supplies as a controller and regarding components other than the distributed power supply in the power grid as a control target.

6. The distributed power supply integration management device according to claim 1, wherein
the control parameter determination circuit determines the control parameter value in each of the plurality of distributed power supplies by referring to a preliminarily created lookup table using the operation pattern determined by the operation determination circuit, and
for each of a plurality of the predetermined operation patterns, the lookup table prestores the control parameter value in each of the plurality of distributed power supplies such that the power grid operates in a stable manner.

7. The distributed power supply integration management device according to claim 1, further comprising
a learning circuit to learn a relationship between the control parameter value in each of the plurality of distributed power supplies and information about operation stability of the power grid, wherein
the control parameter determination circuit determines the control parameter value in each of the plurality of distributed power supplies, using an output from the learning circuit when the operation pattern determined by the operation determination circuit is used as an input to the learning circuit.

8. The distributed power supply integration management device according to claim 1, wherein
the operation pattern includes a combination of operation start commands or operation stop commands for the plurality of distributed power supplies.

9. The distributed power supply integration management device according to claim 1, wherein
the operation pattern includes a combination of output active power command values of the plurality of distributed power supplies.

10. The distributed power supply integration management device according to claim 1, further comprising
a storage circuit to store information about a facility configuration of the power grid, wherein
the control parameter determination circuit determines the control parameter value in each of the plurality of distributed power supplies based on the information obtained from the reception circuit and the information stored in the storage circuit.

11. The distributed power supply integration management device according to claim 10, wherein
the plurality of distributed power supplies are electrically connected to a common bus of the power grid, and
the information stored by the storage circuit includes information about an impedance between each of the plurality of distributed power supplies and the common bus.

12. The distributed power supply integration management device according to claim 1, wherein
the information received by the reception circuit includes an output active power measurement value of each of the plurality of distributed power supplies.

13. The distributed power supply integration management device according to claim 1, wherein
the information received by the reception unit includes information about an amplitude and a phase of the output voltage of each of the plurality of distributed power supplies.

14. The distributed power supply integration management device according to claim 13, wherein
the information received by the reception circuit includes measurement values of the output voltage and an output current of each of the plurality of distributed power supplies, and
the reception circuit calculates output active power of each of the plurality of distributed power supplies based on the measurement values.

15. (canceled)

16. The distributed power supply integration management device according to claim 1, wherein
the operation command transmitted by the transmission circuit includes an operation start command or an operation stop command for each of the plurality of distributed power supplies.

17. The distributed power supply integration management device according to claim 1, wherein
the operation command transmitted by the transmission circuit includes an output active power command value of each of the plurality of distributed power supplies.

18. The distributed power supply integration management device according to claim 1, wherein
in response to a lapse of a predetermined certain time period or a change in a plurality of items constituting the information received by the reception circuit, the operation determination circuit newly generates the operation pattern based on the information at this time point.

19. A power system comprising:
a power grid having a plurality of distributed power supplies connected thereto, output voltages of the plurality of distributed power supplies being controlled by virtual synchronous generator control that implements operation characteristics of a synchronous generator in a static power supply in a simulative manner;
the distributed power supply integration management device as recited in claim 1; and
a communication path formed between the distributed power supply integration management device and the plurality of distributed power supplies.

20. The power system according to claim 19, wherein
each of the plurality of distributed power supplies includes:
a power conversion device operating as the static power supply to convert electric power from a power supply into AC power to be output to the power grid; and
a control device to control the power conversion device to output an AC voltage in accordance with the virtual synchronous generator control.
